(19) United States
(12) Patent Application Publication
(10) Pub. No.: US 2020/0265245 A1
(43) Pub. Date: Aug. 20, 2020

(54) METHOD AND SYSTEM FOR AUTOMATIC GENERATION OF LANE CENTERLINE

(71) Applicants: Chongqing Jinkang New Energy Automobile Co., Ltd., Chongqing (CN); SF Motors Inc., Santa Clara, CA (US)

(72) Inventor: Rui Guo, Santa Clara, CA (US)

(21) Appl. No.: 16/278,726

(22) Filed: Feb. 19, 2019

(51) Int. Cl. G06K 9/00; G06K 9/44; G01C 21/36

(52) U.S. Cl. CPC G06K 9/00798; G01C 21/3673; G06K 9/44

(57) ABSTRACT

Embodiments provide a method and system for automatic generation of lane centerline. A sensor of the vehicle receives road information regarding a road the vehicle travels on, wherein the road information includes road points detected by the sensor. Road points representing left and right lines of a lane in the road is determined from the road information. Road points are connected to obtain the left and right lines of the lane. The left and right lines are smoothed using a smoothing algorithm. Confidence value for the smoothed lines is determined based on the smoothing algorithm and the road points. A centerline of the lane is obtained based on the smoothed lines and the confidence value. Finally smoothing the centerline using the smoothing algorithm.

### FIELD OF THE INVENTION

This invention relates generally to method and system for automatic generation of lane centerline.

### BACKGROUND OF THE INVENTION

The center of the lane in each lane segment is one of the key for the planning module in autonomous driving vehicles. So with help of the localization function, it is essential for the lane center control or similar function to keep the vehicle near the lane centerline. The location of centerline could be generated in the mapping module as a feature. However, the lane centerline could not be labelled since it is a virtual essence. Thus, in order to get the lane centerline, an accurate, fast and automated process is required, which is proposed in this patent.

### BRIEF SUMMARY OF THE INVENTION

A concept is proposed here as Centerline Generator, short as CLG, whose task is to interface with the lane centerline and eventually output the lane centerline. CLG would have two modes, online-mode and offline-mode, that could be configured per request before start of the algorithm. The online-mode would generate a lane centerline during the driving stage, while the offline-mode is conducted forehands to provide the lane centerline information. Operation process includes the following four steps.

First, select the left and right line segments of the lane. In online mode, Based on vehicle position, a portion of the lines is selected. The look ahead distance and look back distance are configurable parameters. In offline mode, relative longer lines regardless of vehicle position could be selected.

Second, smoothing is applied to both left and right lines. Given the fact that the route path could be of different length with complex curve, a two-dimensional spline curve fitting method may be applied to smooth the lane lines. A spline contains of multiple polynomials with certain highest order predefined. Each spline segment could be described as two polynomials in global x and y coordination. Taken the map points as ground truth, the splines are evaluated base on the deviation to the map points, which could be minimized with certain tolerances. The boundary constrains between each polynomial is guaranteed as continuous at anchor points, curvature continuous and the derivative of curvature continuous.

Third, a preliminary lane centerline is generated base on the smoothed lane lines. A confidence value is defined as a parameter and configurable to evaluate the impact of left and right line. If both the left and the right lines are present at relative high confidence level, the lane centerline could be calculated based on the following logic: Centerline position=(left lane position)*confidence value+(right lane position)*(1−confidence value). Normally the lane centerline takes the left and right lines with same confidence value as 0.5. If only one side of the lines is known, an offset of the lane width is applied along the perpendicular direction to the map point on the vehicle side.

Fourth, the same smoothing is then applied to the preliminary lane centerline to generate the final smoothed lane centerline.

The algorithm is currently deployed after the creation of high definition map. Potentially the method could be implemented in compensation to an existing map to fill in lane centerline information. Both the offline and online modes apply to all kinds of lane centerlines as long as the location of each point on the lane lines is available. The online mode to generate lane centerline could also be used to interface the lanes detected from the perception module such as camera, Mobileye or LIDAR.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

FIG. 1 generally illustrates a system for automatic generation of lane centerline in accordance with the disclosure.

FIG. 2 illustrates a block diagram of an embodiment of a system for building a lane centerline using data gathered by the vehicle-based system.

FIG. 3 illustrates one exemplary method for automatic generation of lane centerline in accordance with the disclosure.

FIG. 4 illustrates a simplified computer system, according to an exemplary embodiment of the present disclosure.

### DETAILED DESCRIPTION OF THE INVENTION

In accordance with the disclosure, embodiments can provide a method and system for automatic generation of lane centerline. Various specific embodiments of the present disclosure will be described below with reference to the accompanying drawings constituting a part of this specification. It should be understood that, although structural parts and components of various examples of the present disclosure are described by using terms expressing directions, e.g., “front”, “back”, “upper”, “lower”, “left”, “right” and the like in the present disclosure, these terms are merely used for the purpose of convenient description and are determined on the basis of exemplary directions displayed in the accompanying drawings. Since the embodiments disclosed by the present disclosure may be set according to different directions, these terms expressing directions are merely used for describing rather than limiting. Under possible conditions, identical or similar reference numbers used in the present disclosure indicate identical components.

Automatic generation of lane centerline may require information that an autonomous driving system or driver-assistance system can use to operate or drive a vehicle with an increased amount of safety and/or efficiency. To generate such a lane centerline, a vehicle may be driven (either manually by a human driver or autonomously) on a roadway while an onboard vehicle system is used to capture information about the lane lines. The captured information may then be processed locally onboard the vehicle and/or remotely at a remote server system to generate a lane centerline. The lane centerline may then be used for controlling a vehicle that is driving on the roadway.

To generate the lane centerline, one or more cameras installed on the vehicle may be used to capture images of the lane lines. Additionally installed on the vehicle may be a LIDAR (light detection and ranging) system that can measure the distance from the LIDAR system to left and right lines of a lane present in the roadway environment. The one or more cameras and the LIDAR system may be calibrated such that a point to which a distance is measured by the LIDAR system can be mapped to a location with an image captured by the camera. An image recognition process may be performed on road image to identify left and right lines of a lane. Unwanted objects, such as road markings other than lane lines, pedestrians, vehicles, traffic lights, signs, obstacles, etc., may be filtered out and not used for creating the lane centerline. Using a combination of the LIDAR distance measurements and the recognized objects from the road image, the location of lane lines may be determined in reference to the vehicle. Global navigation satellite system data may be used to convert the location of the lane lines from the vehicle's frame of reference to a digitized map.

The lane line data may then be stored as part of a database of lane centerline data and may be accessed or otherwise provided to an autonomous driving system on a vehicle. The lane centerline may be used for autonomous driving of a vehicle. An “autonomous driving system” refers to a system that can drive, operate, or pilot a vehicle for a period of time without human input being needed to control the vehicle. The lane centerline data may also be used by a “driver-assistance system.” A driver-assistance system may perform at least some of the tasks that are typically performed by a human driver or serve as a safety failsafe for situations in which a human driver has performed a likely mistaken or incorrect action while driving (e.g., failing to brake for a red traffic light, drifting out of a lane, failing to stop or slow down by an appropriate distance from an obstacle in the path of the driver's vehicle).

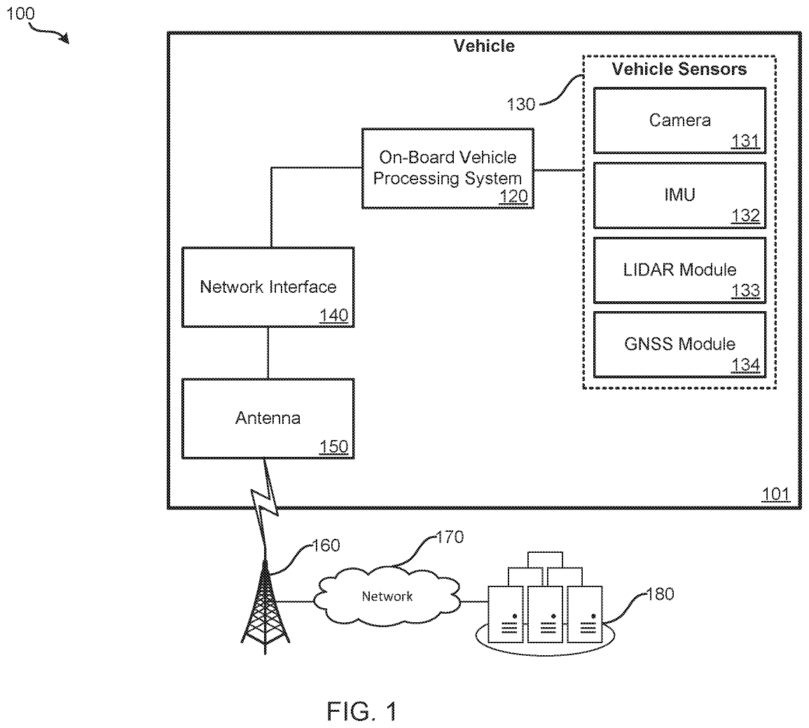

FIG. 1 generally illustrates a system for automatic generation of lane centerline in accordance with the disclosure. As show, a system 100 configured for automatic generation of lane centerline may be provided within the vehicle 101. Vehicle 101 can refer to various forms of vehicles. Vehicle 101 may be a passenger car, pickup truck, sport utility vehicle, truck, motorized cart, all-terrain vehicle, motorcycle, powered scooter, or some other form of powered vehicle. Such vehicles may be configured to be controlled by a human driver (hereinafter a “driver”), an autonomous driving system (or driver-assistance system), or both. Therefore, at least in some vehicles, a driver may control the vehicle, while at other times the autonomous driving system may control the vehicle. Embodiment 100 may include: vehicle 101; onboard vehicle processing system 120; vehicle sensors 130; network interface 140; antenna 150; cellular network 160; network 170; and map server system 180.

Vehicle sensors 130 can include: camera 131, IMU (inertial measurement unit) 132, LIDAR module 133; and GNSS (global navigation satellite system) module 134. As part of vehicle sensors 130, camera 131 may be present. In some embodiments, more than one camera may be present. Multiple cameras may have different or overlapping fields-of-views. In some embodiments, the angle of field-of-view is different, such as for short-range and long-range cameras. Camera 131 may be a visible light camera that has a field-of-view of the environmental scene in front and/or back of vehicle 101. LIDAR module 136 may be used to determine the distance to lane lines in the roadway environment of vehicle 101. Camera 131, LIDAR module 136, and onboard vehicle processing system 120 may be calibrated such that a LIDAR measurement can be mapped to a particular location within an image captured by camera 131. LIDAR module 133 may capture a point cloud that represents distances from LIDAR module 133 to the lane lines in a variety of directions. Therefore, for a given road image, multiple points (e.g., tens, hundreds) from a captured point cloud may be mapped to different locations with the image. These points are representative of the measured distance from the vehicle or LIDAR module to lane lines present within the image.

GNSS module 134 may use one or more GNSS satellite systems to determine a precise location of GNSS module 134 and, thus, by extension, vehicle 101 on which GNSS module 134 is installed. GNSS module 134 may use GPS, GLONASS, Galileo, BeiDou (BDS) or some other form of navigation satellite system to determine a location of vehicle 101. IMU 132 may be used to determine the speed and direction of vehicle 101. This data may be used alternatively or in addition to speed and direction data obtained from GNSS module 134.

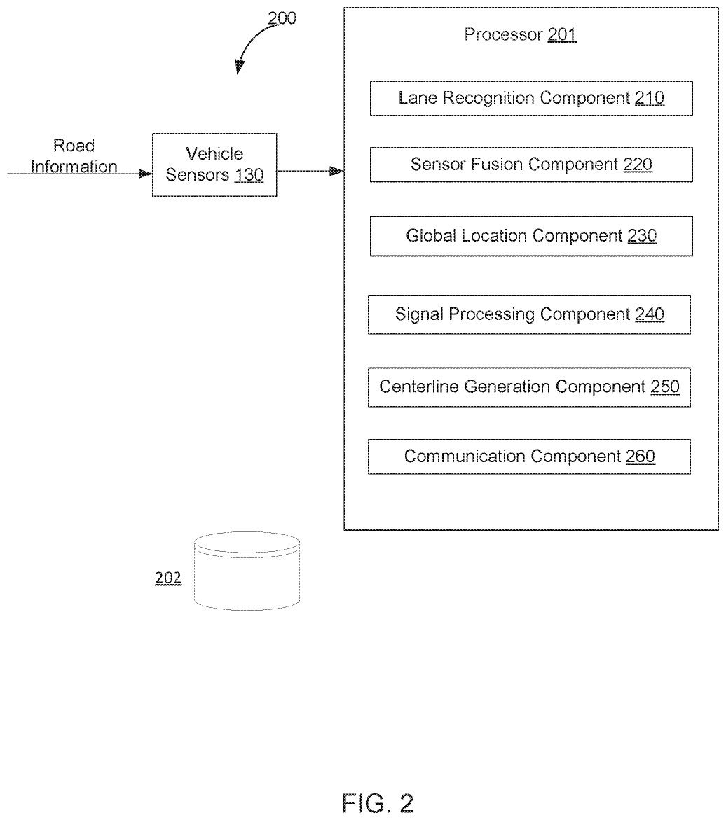

Onboard vehicle processing system 120 may receive data from vehicle sensors 130. Onboard vehicle processing system 120 may further communicate with map server system 180 through network interface 140 and antenna 150. Onboard vehicle processing system 120 may include various computerized components, such as one or more processors and communication busses. The one or more processors used as part of onboard vehicle processing system 120 may include one or more specific-purpose processors that have various functionality hardcoded as part of the one or more processors, such as an application-specific integrated circuit (ASIC). Additionally or alternatively, one or more general-purpose processors may be used as part of onboard vehicle processing system 120 that execute stored instructions that cause the general-purpose processors to perform specific-purpose functions. Therefore, software and/or firmware may be used to perform at least some of the functions of onboard vehicle processing system 120. Further detail regarding the functioning of onboard vehicle processing system 120 is provided in relation to FIG. 2.

In some embodiments, onboard vehicle processing system 120 performs processing on road image from camera 131 and processing on point-cloud data received from LIDAR module 133. Onboard vehicle processing system 120 may be used to perform an object recognition process on road image to identify lane lines. Onboard vehicle processing system 120 may map distances measured using the LIDAR module 133 to locations in road image. The absolute location of lane lines may be determined by analyzing location data obtained from GNSS module 134 to lane lines identified in the images and distances measured using LIDAR module 133. In other embodiments, some or all of this processing may be performed remotely at map server system 180.

Network interface 140 may be used to facilitate communication between onboard vehicle processing system 120 and various external sources. In some embodiments, network interface 140 uses antenna 150 to wirelessly communicate with cellular network 160, which may be a 3G, 4G, 5G, or some other form of wireless cellular network. Cellular network 160 may use one or more networks 170, which can include the Internet, to communicate with a remote map server system 180. Map server system 180 may be operated by an entity that creates and stores lane centerline data for use by autonomous vehicles. For instance, map server system 180 may be operated by (or have operated on its behalf) a manufacturer or provider of autonomous vehicles or autonomous driving services. Therefore, map server system 180 may communicate with a large number (e.g., thousands) of autonomous driving systems deployed in geographically-scattered vehicles. Network interface 140 may also be able to communicate with other forms of wireless networks. For instance, network interface 140 may be used to communicate with a wireless local area network (WLAN), such as a Wi-Fi network to which autonomous driving system has permission to access. For example, when parked at a home or office, vehicle 101 may be within range of a Wi-Fi network, through which the Internet and map server system 180 may be accessed. Other forms of network-based communication with map server system 180 are possible, such as a Bluetooth communication link via a vehicle occupant's mobile device to a cellular network or WLAN. In other embodiments, rather than wirelessly transmitting data to map server system 180, data captured using vehicle sensors 130 may be stored locally onboard vehicle 101, such as to a solid state drive or other form of non-transitory processor-readable medium. The captured data may then be transferred to the map server system, such as via a wired communication arrangement or by a removable form of non-transitory processor-readable medium being used (e.g., flash memory, solid state drive).

FIG. 2 illustrates a block diagram of an embodiment of a system 200 for building a lane centerline using data gathered by the vehicle-based system. System 200 represents various components that may be implemented using specialized hardware or software executed by one or more general-purpose processors, for example, one or more specific-purpose processors that have various functionalities hardcoded as part of the one or more processors, such as an ASIC. Further, the various components of system 200 may be part of onboard vehicle processing system 120 or map server system 180. In some embodiments, the functionality of some components may be part of onboard vehicle processing system 120 while others are performed remotely as part of map server system 180.

As shown, the system 200 may include one or more of a processor 201 configured to implement computer program components, a storage device 202 and/or any other components. The computer program components can include a lane recognition component 210, a sensor fusion component 220, a global location component 230, a signal processing component 240, a centerline generation component 250, a communication component 260 and/or any other components. All these components are illustrated in FIG. 2 as separate elements for purposes of clarity and discussion. It will be appreciated these components may be integrated into a single module. Moreover, it will be appreciated that each of these components, or an integrated module, may include a suitable processing device, such as a microprocessor, digital signal processor, etc., one or more memory devices including suitably configured data structures, and interfaces to couple the system 200 to various vehicle sensors and to interface with other entities.

In some embodiments, the system 200 may be arranged within the vehicle 101. In those embodiments, the system 200 may be configured to communicate with various sensors and devices for the lane data described herein through short range communication methods, such as Bluetooth, WiFi and/or any short range communication methods. In some embodiments, the system 200 may be arranged within a control center, for example as a remote server provided by the control center. In those embodiments, the system 200 may be configured to communicate with the various sensors and devices through a communications network.

Lane recognition component 210 may be configured to receive road information including road points. In some embodiments, the lane recognition component 210 can receive road image captured by the camera 131 and road points captured by the LIDAR module 133, and identify lane lines from the road image. A road image may be received periodically, such as every 500 ms. Each road image may be initially processed using the lane recognition component 210. Lane recognition component 210 may be trained to recognize various types of objects. Such types of objects can include: vehicles; pedestrians; traffic lights; fixed structures; lane lines; road markings other than lane lines; curbs; fixed obstacles; traffic islands; traffic signs; etc.

Lane recognition component 210 may use a neural network or other form of deep-learning-based object recognition module. If lane recognition component 210 is based on deep learning, lane recognition component 210 may have initially been provided with a large set of images that have the object types that are desired to be identified properly tagged. This set of images may be used to train lane recognition component 210 to properly recognize lane lines. Once properly trained and tested, lane recognition component 210 may operate on received images without human intervention or monitoring. That is, lane recognition component 210 may be able to recognize the lane lines without a human manually tagging the lane lines. In some embodiments, a human may perform some level of review to confirm that each lane line were correctly located and tagged.

Of the trained object types, both unwanted and wanted objects are present. Unwanted objects are objects that the system don't need for purpose of generation of lane centerline. For example, road markings other than lane lines, pedestrians, vehicles, traffic lights, signs, obstacles are types of unwanted objects. Wanted objects are left and right lines of the lane. Such objects can be expected to be fixed in position unless roadway construction changes the configuration of lanes. Lane recognition component 210 may serve to tag or otherwise select unwanted objects that are to be removed from inclusion in the output data. Lane recognition component 210 may be configured to remove all types of unwanted objects. Lane recognition component 210 may be reconfigured to include additional or fewer types of unwanted objects. The output of the lane recognition component 210 includes LIDAR data obtained from LIDAR module 133 and lane line data present in road image recognized by lane recognition component 210. In some embodiments, the output of the lane recognition component 210 is fed to the sensor fusion component 220 and/or other devices for further processing.

The sensor fusion component 220 may be configured to fuse and calibrate data received from vehicle sensors 130. In some embodiments, the sensor fusion component 220 receives data from the lane recognition component 210 and/or other devices. The sensor fusion component 220 may serve to fuse LIDAR data obtained from LIDAR module 133 and lane line data present in road image recognized by lane recognition component 210. LIDAR data may be in the form of a point cloud that includes distance measurements in a direction in which the distance measurement was made. LIDAR data may be captured at the same time or a similar time as the image with which the LIDAR data is being fused by the sensor fusion component 220. That is, while camera 131 is capturing an image of lane lines, LIDAR module 133 may be capturing a point cloud representative of distances to lane lines present within the image. Therefore, in order for the point cloud to be accurately representative of the distances to lane lines within the image, the point cloud may be captured within a threshold time of when the image was captured, such as 100 ms. The sensor fusion component 220 may be calibrated such that particular road points from within the captured point cloud are mapped to locations within the road image. By using these mapped locations, the distance to the lane lines identified by lane recognition component 210 within the road image can be determined. The output of the sensor fusion component 220 may be calibrated road points and identified lane lines in road image. The output of the sensor fusion component 220 may be passed to global location component 230.

Global location component 230 may be configured to determine road points representing left and right line. In some embodiments, global location component 230 may receive GNSS data from GNSS module 134. Global location component 230 may convert the location data to a digitized map. The received GNSS data may indicate a precise location in the form of global coordinates. These global coordinates may be obtained at the same or approximately the same time as LIDAR data and road image were obtained. In some embodiments, the global coordinates may be obtained within a threshold period of time, such as 100 ms, of when road image and LIDAR data were obtained. Using the global coordinates and location data, global location component 230 may determine the global location of the lane lines, and determine road points representing left and right line. The location data of detected lane lines may be output as map-road information. The map-road information may be added to a lane centerline database that may be later accessed to help control a vehicle performing autonomous driving.

Centerline generation component 250 may be configured to connect road points to obtain left and right line; smooth left and right line using smoothing algorithm; determine confidence value for smoothed left and right line; obtain centerline based on smoothed left and right line, and confidence value; and smooth centerline using smoothing algorithm.

In some embodiments, connecting road points to obtain left and right line can be done by known technology, such as interpolation method.

Programs, techniques, and algorithms for smoothing data points are known. In some embodiments, the smoothing algorithm is a two-dimensional spline curve fitting algorithm. With spline curves, and in particular, Bezier curves, curving lanes are represented by polynomial equations whose coefficients have been determined so as to generate lane centerline that match the shapes of the geographic features with the desired degree of accuracy. A property of Bezier curves is that they are defined by their two end points and two additional control points. These control points are positioned along the tangents to the curve at the end points. Bezier curves can closely approximate S-curves, circular arcs, parabolic shapes and even straight lines. Standard techniques for fitting polynomial curves to point series can be employed to find the control point coordinates that give a best-fit Bezier curve for any particular series of shape points used in a straight-line-segment approximation to a curve in a geographic database.

Another way to implement the smoothing is to use a least-squares fitted to a cubic equation. Still another way to implement smoothing is to use a Kalman filter. The Kalman filter technique weighs each individual sensor error tolerance to determine how to smooth the points. Using the smoothing algorithm, the left and right line, and finally the centerline are smoothed. The smoothing process results in a plurality of smoothed centerline. In some embodiments, the smoothing step can be performed by a program on the same computer that performed the fusing step or alternatively, the smoothing step may be performed on a different computer. The program that performs the smoothing step may be included among the programs installed on one of the workstation computers at the field office.

The confidence value indicates degree of accuracy of the smoothed left and right lines. In some embodiments, the confidence value of the smoothed left and right lines may be based on road points representing left and right lines, identified lane lines in road image, and map-road information. The summation of the first confidence value for the smoothed left line and the second confidence value for the smoothed right line is 1. In some embodiments, if difference of the confidence value between the smoothed left and right lines is within a preset threshold, such as 5%, then the system can set the confidence value of the smoothed left and right lines as identical. Otherwise the second confidence value=1−(the first confidence value).

In some embodiments, when the second confidence value is equal to: 1−(the first confidence value), the centerline is obtained using the following formula: centerline=(the smoothed left line)×(the first confidence value)+(the smoothed right line)×(1−the confidence value). If only one side of the lines is known, an offset of the lane width is applied along the perpendicular direction to the map point on the vehicle side. In some embodiments, when the system determines that points on the right line are missing, the system can estimate the centerline based on the smoothed left line only, and the centerline=(the smoothed left line)+(the width of the lane)/2.

The signal processing component 240 can be configured to process the signals received from the vehicle sensors. In any case, after receiving the signals received from the vehicle sensors, the signal processing component 240 may transcribe analog signals to digital signals based on needs of the system.

The communication component 260 can be configured to communicate the signals received by the signal processing component 240 and/or any other information to a control center, and/or any other entities. The communication component 260 can also be configured to communicate the smoothed centerline generated by the centerline generation component 250 and/or any other information from a control center to various vehicles or entities. The communication component 260 can be configured to communicate such information via a communications network.

The storage device 202 may be configured to store user data described herein. In implementations, the storage device 202 may include a memory storage device, a disk storage device, a cloud storage device, and/or any other type of storage device.

It should be understood the above-described functionalities attributed to system 200 can be implemented within the vehicle 101. However, this is not necessarily the only case. In certain embodiment, part of or the entire functionalities attributed to system 200 herein can be implemented at the control center. For example, the control center may comprise a server that can be configured to perform part of the operations provided by system 200 as described above.

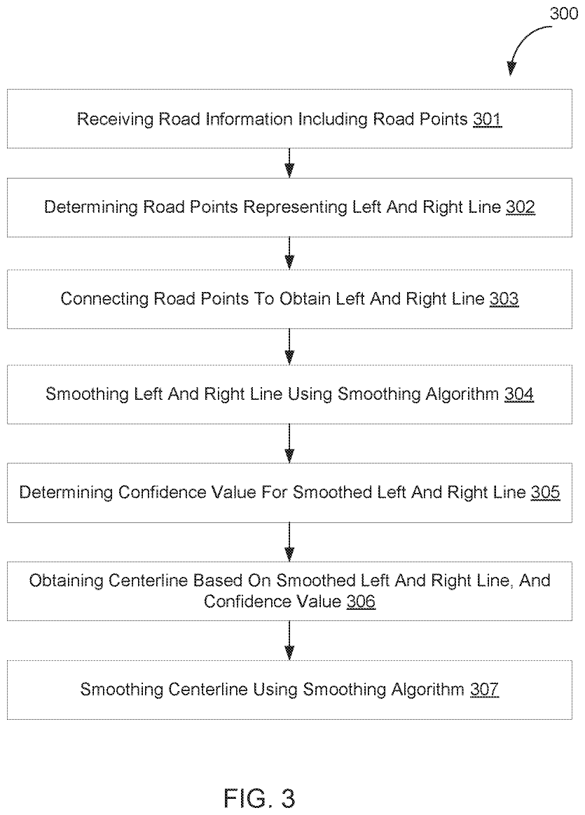

FIG. 3 illustrates one exemplary method for automatic generation of lane centerline in accordance with the disclosure. The operations of method 300 presented below are intended to be illustrative. In some embodiments, method 300 may be accomplished with one or more additional operations not described and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At 301, the method 300 includes receiving road information regarding a road the vehicle travels on, wherein the road information includes road points detected by the sensor. In some implementations, operation 301 can be performed by a lane recognition component substantially similar to or the same as the lane recognition component 210 as described and illustrated herein. At 301, one or more images of the lane lines may be captured from a vehicle that is traveling on the roadway. The image may be time stamped. Simultaneously or within a threshold period of time earlier or later than the capturing of the one or more images, a LIDAR point cloud of the lane lines may be created based on LIDAR measurements made from the vehicle. Each point within the point cloud may have a particular direction and distance. The LIDAR point cloud may also be associated with the timestamp. At the same time or within a threshold period of time earlier or later than the capturing of the one or more images, a GNSS module may be used to determine an absolute position of a GNSS module present on the vehicle, and therefore can be used as indicative of the vehicle's absolute location. The GNSS data may also be associated with the timestamp. The timestamps of the LIDAR point cloud, the road image, and the GNSS data may be compared to determine whether all of such data was captured within a threshold period of time. If all of such data was captured within a threshold period of time, then all of such data can be used to determine road points representing left and right line, as illustrated at step 302.

At 302, the method 300 includes determining, from the road information, road points representing left and right line of a lane in the road. In some implementations, operation 302 can be performed by a global location component substantially similar to or the same as the global location component 230 as described and illustrated herein.

At 303, the method 300 includes connecting the road points to obtain the left and right line of the lane. In some implementations, operation 303 can be performed by a centerline generation component 250 substantially similar to or the same as the first centerline generation component 250 as described and illustrated herein.

At 304, the method 300 includes smoothing the left and right line using a smoothing algorithm. In some implementations, operation 304 can be performed by a centerline generation component 250 substantially similar to or the same as the first centerline generation component 250 as described and illustrated herein.

At 305, the method 300 includes determining confidence value for the smoothed left and right line based on the smoothing algorithm and the road points, wherein the confidence value indicates a degree of accuracy of the smoothed line. In some implementations, operation 305 can be performed by a centerline generation component 250 substantially similar to or the same as the first centerline generation component 250 as described and illustrated herein.

At 306, the method 300 includes obtaining a centerline of the lane based on the smoothed left and right line of the lane, and the confidence value. In some implementations, operation 306 can be performed by a centerline generation component 250 substantially similar to or the same as the first centerline generation component 250 as described and illustrated herein.

At 307, the method 300 includes smoothing the centerline using the smoothing algorithm. In some implementations, operation 307 can be performed by a centerline generation component 250 substantially similar to or the same as the first centerline generation component 250 as described and illustrated herein.

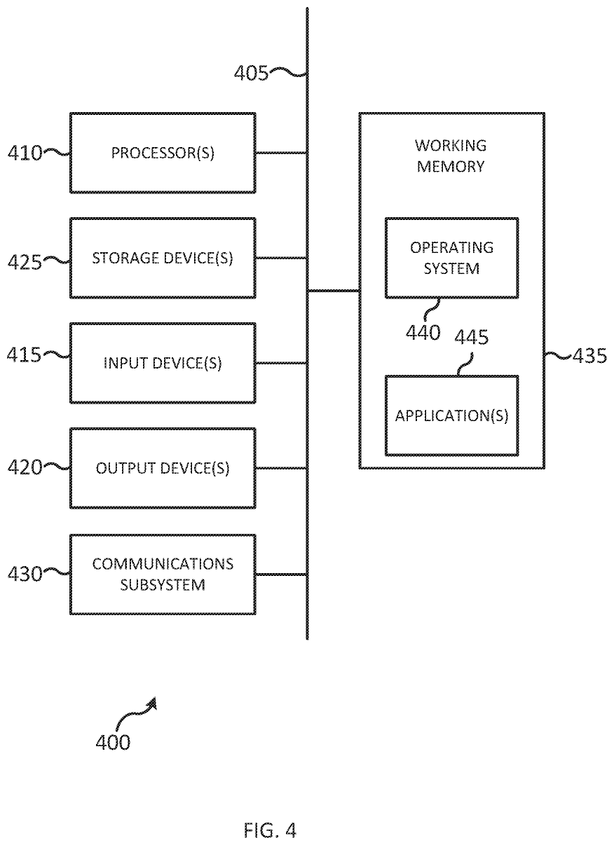

FIG. 4 illustrates a simplified computer system that can be used implement various embodiments described and illustrated herein. A computer system 400 as illustrated in FIG. 4 may be incorporated into devices such as a portable electronic device, mobile phone, or other device as described herein. FIG. 4 provides a schematic illustration of one embodiment of a computer system 400 that can perform some or all of the system provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 415, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 425, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset such as a Bluetooth™ device, an 1002.11 device, a WiFi device, a WiMax device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g. the first electronic device, may be incorporated into the computer system 400, e.g., an electronic device as an input device 415. In some embodiments, the computer system 400 will further comprise a working memory 435, which can include a RAM or ROM device, as described above.

The computer system 400 also can include software elements, shown as being currently located within the working memory 435, including an operating system 440, device drivers, executable libraries, and/or other code, such as one or more application programs 445, which may comprise computer programs provided by various embodiments, and/or configure systems, provided by other embodiments, as described herein. Merely by way of example, one or more procedures described with respect to the system discussed above, such as those described in relation to FIG. 4, might be implemented as code and/or instructions executable by a computer and/or a processor within a computer; in an aspect, then, such code and/or instructions can be used to configure and/or adapt a general purpose computer or other device to perform one or more operations in accordance with the described system.

A set of these instructions and/or code may be stored on a non-transitory computer-readable storage medium, such as the storage device(s) 425 described above. In some cases, the storage medium might be incorporated within a computer system, such as computer system 400.

In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 400 to perform system in accordance with various embodiments of the technology. According to a set of embodiments, some or all of the procedures of such methods are performed by the computer system 400 in response to processor 410 executing one or more sequences of one or more instructions, which might be incorporated into the operating system 440 and/or other code, such as an application program 445, contained in the working memory 435. Such instructions may be read into the working memory 435 from another computer-readable medium, such as one or more of the storage device(s) 425. Merely by way of example, execution of the sequences of instructions contained in the working memory 435 might cause the processor(s) 410 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many embodiments, a computer-readable medium is a physical and/or tangible storage medium. Such a medium may take the form of a non-volatile media or volatile media. Non-volatile media include, for example, optical and/or magnetic disks, such as the storage device(s) 425. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 405 then might carry the signals and/or the data, instructions, etc. carried by the signals to the working memory 435, from which the processor(s) 410 retrieves and executes the instructions. The instructions received by the working memory 435 may optionally be stored on a non-transitory storage device 425 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including embodiments. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a sensor” includes a plurality of sensors, and reference to “the processor” includes reference to one or more processors and equivalents thereof known to those skilled in the art, and so forth. Ordinals such as “first sensor” and “second sensor” only mean they may be different. There is no specific sequence unless the context clearly dictates otherwise. Thus, for example, “first sensor” can be described as “second sensor”, and vice versa.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A method of determining lane centerline, the method being implemented by a processor in a vehicle, and the method comprising:
receiving, from a sensor of the vehicle, road information regarding a road the vehicle travels on, wherein the road information includes road points detected by the sensor;
determining, from the road information, a first set of road points representing a left line of a lane in the road;
determining, from the road information, a second set of road points representing a right line of the lane in the road;
connecting the first set of road points to obtain the left line of the lane;
smoothing the left line using a smoothing algorithm;
connecting the second set of road points to obtain the right line of the lane;
smoothing the right line using the smoothing algorithm;
determining a first confidence value for the smoothed left line based on the smoothing algorithm and the first set of road points, wherein the first confidence value indicates a degree of accuracy of the smoothed left line;
determining a second confidence value for the smoothed right line based on the smoothing algorithm and the second set of road points, wherein the second confidence value indicates a degree of accuracy of the smoothed right line;
obtaining a centerline of the lane based on the smoothed left line of the lane, the first confidence value, the smoothed right line of the lane, and the second confidence value; and
smoothing the centerline using the smoothing algorithm.

2. The method of claim 1, further comprising:
obtaining a location of the vehicle;
based on the location of the vehicle, obtaining, from a digitized map, map-road information; and
augmenting the road information with the map-road information.

3. The method of claim 1, wherein a given point on the left line indicates a coordinate of the left line at the given point on the left line, and a given point on the right line indicates a coordinate of the right line at the given point on the left line.

4. The method of claim 1, wherein the second confidence value is obtained based on the first confidence value.

5. The method of claim 4, wherein the second confidence value is equal to: 1−(the first confidence value).

6. The method of claim 5, wherein the centerline is obtained using the following formula:
centerline=(the smoothed left line)×(the first confidence value)+(the smoothed right line)×(1−the first confidence value).

7. The method of claim 1, further comprising:
determining one or more points on the right line are missing when connecting the second set of road points; and
in response to the determination that one or more points on the right line are missing, estimating the centerline based on the smoothed left line only.

8. The method of claim 7, wherein estimating the centerline includes obtaining a width of the lane, and estimating the centerline uses the following formula:
centerline=(the smoothed left line)+(the width of the lane)/2.

9. The method of claim 1, wherein the smoothing algorithm is a two-dimensional spline curve fitting algorithm.

10. The method of claim 1, wherein the sensor is at least one of a camera, an IMU (inertial measurement unit), a lidar (light detection and ranging) sensor, and a GNSS (global navigation satellite system) sensor. A system for determining lane centerline, the system comprising a processor in a vehicle configured to execute machine-readable instructions, wherein when the machine-readable instructions are executed, the processor is caused to perform:
receiving, from a sensor of the vehicle, road information regarding a road the vehicle travels on, wherein the road information includes road points detected by the sensor;
determining, from the road information, a first set of road points representing a left line of a lane in the road;
determining, from the road information, a second set of road points representing a right line of the lane in the road;
connecting the first set of road points to obtain the left line of the lane;
smoothing the left line using a smoothing algorithm;
connecting the second set of road points to obtain the right line of the lane;
smoothing the right line using the smoothing algorithm;
determining a first confidence value for the smoothed left line based on the smoothing algorithm and the first set of road points, wherein the first confidence value indicates a degree of accuracy of the smoothed left line;
determining a second confidence value for the smoothed right line based on the smoothing algorithm and the second set of road points, wherein the second confidence value indicates a degree of accuracy of the smoothed right line;
obtaining a centerline of the lane based on the smoothed left line of the lane, the first confidence value, the smoothed right line of the lane, and the second confidence value; and
smoothing the centerline using the smoothing algorithm.

12. The system of claim 11, further comprising:
obtaining a location of the vehicle;
based on the location of the vehicle, obtaining, from a digitized map, map-road information; and
augmenting the road information with the map-road information.

13. The system of claim 11, wherein a given point on the left line indicates a coordinate of the left line at the given point on the left line, and a given point on the right line indicates a coordinate of the right line at the given point on the left line.

14. The system of claim 11, wherein the second confidence value is obtained based on the first confidence value.

15. The system of claim 14, wherein the second confidence value is equal to: 1−(the first confidence value).

16. The system of claim 15, wherein the centerline is obtained using the following formula:
centerline=(the smoothed left line)×(the first confidence value)+(the smoothed right line)×(1−the first confidence value).

17. The system of claim 11, further comprising:
determining one or more points on the right line are missing when connecting the second set of road points; and
in response to the determination that one or more points on the right line are missing, estimating the centerline based on the smoothed left line only.

18. The system of claim 17, wherein estimating the centerline includes obtaining a width of the lane, and estimating the centerline uses the following formula:
centerline=(the smoothed left line)+(the width of the lane)/2.

19. The system of claim 11, wherein the smoothing algorithm is a two-dimensional spline curve fitting algorithm.

20. The system of claim 11, wherein the sensor is at least one of a camera, an IMU (inertial measurement unit), a lidar (light detection and ranging) sensor, and a GNSS (global navigation satellite system) sensor.
